(19) United States
(12) Patent Application Publication
(10) Pub. No.: US 2026/0280726 A1
(43) Pub. Date: Sep. 17, 2026

(54) SUBTERRANEAN COMMUNICATIONS SYSTEM AND METHOD

(71) Applicant: CMTE DEVELOPMENT LIMITED, Pinjarra Hills (AU)

(72) Inventors: DYLAN WHITEMAN, Pinjarra Hills (AU); ALEXANDER TEAKLE, Pinjarra Hills (AU); EDWARD PROCHON, Pinjarra Hills (AU); BYRON NEIL WICKS, Pinjarra Hills (AU); JOSE DAVID APOLO CANDO, Pinjarra Hills (AU); LUKE VAN, Pinjarra Hills (AU)

(73) Assignee: CMTE DEVELOPMENT LIMITED, Pinjarra Hills (AU)

(21) Appl. No.: 19/472,488

(22) PCT Filed: Apr. 4, 2024
(86) PCT No.: PCT/AU2024/050324

§ 371 Date: Oct. 3, 2025

(30) Foreign Application Priority Data
Apr. 4, 2023 (AU) 2023900984

(51) Int. Cl. H04B 13/02; E21B 47/125

(52) U.S. Cl. CPC H04B 13/02; E21B 47/125

(57) ABSTRACT

An underground wireless transmission system including: a sensor for sensing the underground environment and producing a corresponding data value; a data value transmission unit for transmitting the data value to the surface, the transmission unit providing an encoded low frequency magnetic oscillating field, modulated with the data value; a surface receiver unit including a magnetic sensor for sensing the encoded low frequency magnetic oscillating field and demodulating the data value from the field; and a surface control unit connected to the surface receiver unit for collation of the data values from one or more surface control units.

### RELATED APPLICATION

This is a US national stage filing under 35 USC 371 of PCT International Application No. PCT/AU2024/050324, filed on Apr. 4, 2024 and entitled “Subterranean Communications System and Method”, which claims benefit of priority to Australian Patent Application Number: 2023900984 filed 4 Apr. 2023, entitled: ‘Subterranean communications system and method’, the contents of which are incorporated herein by reference. In jurisdictions where incorporation by reference is not permitted, the applicant reserves the right to add any or the whole of the contents of said Australian Provisional Patent Application Number: 2023900984 as an Appendix hereto, forming part of the specification.

### FIELD OF THE INVENTION

The present invention relates to communication systems for communicating information in harsh environments, such as subsurface environments.

### BACKGROUND OF THE INVENTION

Any discussion of the background art throughout the specification should in no way be considered as an admission that such art is widely known or forms part of common general knowledge in the field.

In mining operations, there is a general need to measure a number of phenomena including but not limited to underground temperature and pressure. This requirement is often needed in extremely harsh mining environments.

For example, the underground environment may exist in elevated temperature and pressure conditions, with unstable rock. One example environment is the geothermal open pit gold mine at Lihir. Lihir is situated on a volcanic island and presents significant geothermal challenges to the mining operation. In particular, but not limited to, very high rock temperatures, saturated steam, and surface steam venting.

Current monitoring methods often utilise wired systems to carry out the measurement process. Wired systems are prone to damage when deep holes become sightly displaced (breaking the wires in the holes) or when surface wires are damaged due to blasting activity or machine activity.

Ideally, it is desired to measure such conditions wirelessly. An advantage of a wireless system is that underground probes can be installed, and then the mining activity proceed directly above the monitored areas.

A number of desirable characteristics of being able to wirelessly measure in harsh conditions include but are not limited to: Being able to measure ‘deep’ underground temperature and pressure measurement. Being able to obtain an understanding of how the pressure and temperature changes at a given depth over time, as the mining operations bring the surface level closer to the measurement point is important in confirming or calibrating any thermal cooling models. As the mine gets deeper—if the temperatures are too high at the surface, then this presents a number of challenges—including the potential decomposition of blast hole explosives if temperatures reach the 150 degree Celsius region. A sound understating the geothermal behaviour of the site is important for on-going long-term operations.

Unfortunately, traditional wireless systems are unable to effectively operate in difficult environments such as underground environments, due to the excessive attenuation characteristics and difficult environmental conditions.

### SUMMARY OF THE INVENTION

It is an object of the invention, in its preferred form to provide for an improved sensing and communication system operable in difficult environments.

In accordance with a first aspect of the present invention, there is provided an underground low frequency wireless transmitter suitable for use in harsh environments including: a core electronics and battery formed in an elongated unit; an elongated hollow case formed from a high permeability material surrounding the core electronics; a conductive transmission coil wrapped around the elongated case; and at least one environmental sensor interconnected to the core electronics.

In some embodiments, the conductive transmission coil is wrapped around the elongated hollow case in a transverse manner. Preferably, the core electronics and battery are able to undergo sliding movement within said elongated hollow case. The high permeability material can include steel.

In some embodiments, there are endcaps located at each end of the elongated case, where one of the endcaps includes a pressure sensor, and the core electronics and battery are encased in a non conductive resin. The hollow case can include a series of expansion slots for the thermal expansion of the resin into the slots.

In some embodiments, the transmitter includes a transmission scheme utilized by the transmitter utilises Frequency Shift Keying (FSK). Preferably, the FSK lowest frequency is around 20 Hz, with about a 0.1 Hz spacing. A frequency hop spread spectrum scheme can be further added to the frequency shift keying. In some embodiments, the transmission coil is driven by a H-bridge driving circuit.

Preferably, the transmissions occur at a frequency below about 300 Hz, and more preferably the frequency is below about 30 Hz.

In accordance with a further aspect of the present invention, there is provided an underground wireless transmission system including: one or more sensors for sensing the underground environment and producing a corresponding data values; a data value transmission unit for transmitting the data values to the surface, the transmission unit providing an encoded low frequency magnetic oscillating field, modulated with the data value; a surface receiver unit including a magnetic sensor for sensing the encoded low frequency magnetic oscillating field and demodulating the data value from the field; and a surface control unit connected to the surface receiver unit for collation of the data values from one or more surface control units.

Preferably, the data value transmission unit includes a conductive coil driven at a low frequency, below about 300 Hz. In some embodiments, the data value transmission unit can be a rotating permanent magnet.

In some embodiments, the data value transmission unit is encased in a material that protects the transmission unit from the environment, including a number of cavities that allow the protective material to expand into the cavities when increases in temperature occur in the surrounding environment. In some embodiments, the modulation includes a spread spectrum modulation.

In some embodiments, the data value transmission unit transmits data intermittently in accordance with a predetermined schedule. The sensing can include but is not limited to temperature and/or pressure. The surface receiver unit can be solar powered. The magnetic sensor can comprise a three axis magnetometer or whole field magnetometer.

In some embodiments, the data value is encoded in an error corrected format before sending. The encoding format can be Reed Solomon encoding. In some embodiments, the data value is transmitted with a preamble code. The data value can be transmitted utilising Multiple Frequency Shift Keying (MFSK). The data value transmission unit can create the low frequency oscillating field by means of a rotating diametrically magnetised permanent magnet or electric coil.

### BRIEF DESCRIPTION OF THE DRAWINGS

Embodiments of the invention will now be described, by way of example only, with reference to the accompanying drawings in which:

FIG. 1 illustrates schematically the RBS system of a first embodiment;

FIG. 2 illustrates schematically the deployment tool and programming of the wireless remote borehole sensor;

FIG. 3 illustrates an initial exploded side view of internal portions of the RBS sensor;

FIG. 4 illustrates an end pressure cap of the RBS sensor;

FIG. 5 illustrates an end view of the transmitter PCT and chassis inserts;

FIG. 6 illustrates an end view of the transmission batteries and chassis inserts;

FIG. 7 illustrates a side view of the installation end cap;

FIG. 8 illustrates a side view, partly in section, of the transverse winding around the steel core;

FIG. 9 illustrates a side view of one form of steel core and expansion joint;

FIG. 10 illustrates a side view of one form of steel core and expansion joint;

FIG. 11 illustrates a side view of one form of transverse winding;

FIG. 12 illustrates a side view of an alternative form of transverse winding;

FIG. 13 illustrates a side view of an alternative form of radial winding;

FIG. 14 illustrates a side view of an alternative form of radial winding;

FIG. 15 illustrates a side view, partly in section, of an assembled RBS sensor;

FIG. 16 illustrates a side view of an assembled RBS sensor;

FIG. 17 to FIG. 21 illustrate a side view of the same FIG. 3 to FIG. 8 and FIG. 15 and FIG. 16;

FIG. 22 illustrates a schematic block diagram of the electronics of an RBS sensor;

FIG. 23 illustrates a schematic of one form of data structure for sending;

FIG. 24 illustrates schematically a further environment for utilisation autonomous sensing;

FIG. 25 illustrates schematically the electronics of the further embodiment;

FIG. 26 illustrates a flow chart of one form of operation of the second embodiment.

### DETAILED DESCRIPTION

The first embodiments provide for a wireless remote borehole communication system able to operate up to useful transmission ranges of tens to hundreds of meters. The first embodiment is able to operate in a difficult environment and is able to measure temperatures inside blast holes. This provides a significant production process improvement application, because the surface temperatures can fluctuate on site, there is a concern that excessively high temperatures in blast holes can decompose the explosives used in the blasting process. By closely monitoring a subset of the many blast holes, a temperature map can be established and used to optimise the blasting process, by for example, only using explosives that are appropriately temperature rated and not charging holes with explosives if the present temperatures are too high. Blast hole measurements are generally only required to about 50 meters.

The first embodiment provides a wireless system able to transmit data from 10 meters to hundreds of meters through solid or fragmented rock, with operating temperatures up to around 150 deg Celsius. The first embodiment limits the use of capacitors—as the high values capacitors usually used in coil driving circuitry have short operational lives at elevated temperatures. The battery power supply preferably offers high capacity at the high temperatures. With the device providing sealing of the electronics against 30 bar hydrostatic pressures which are present in geothermal environments. The first embodiment maintains measurement linearity over a wide range of environmental temperatures and battery supply voltages.

The first embodiment provides a Wireless Remote Borehole Sensing and Monitoring System (Hereinafter referred to as the RBS System) that enables measurement of underground temperature and pressure in mines using wireless RBS-Sensor probes.

The RBS System utilises underground RBS-Sensors to measure temperature and pressure data. This data is then wirelessly transmitted to the surface using an extremely low frequency magnetic fields, where it is recorded by RBS-Receivers. The frequency of these fields is in the vicinity of about 3 to 300 Hz, or more preferably about 3 to 30 Hz. The receivers send this data to the RBS-Control Station over a Wi-Fi network, where it is decoded into geolocated, timestamped temperature and pressure readings, or other measured data. The RBS-Control Station serves as the central hub for collecting and processing data received from the RBS-Sensors. The data can be downloaded locally from the RBS-Control Station via its Master WiFi or remotely from offices if the RBS-Control Station is connected to the mine's LAN.

The RBS system includes:

Transmission of data through solid or fragmented rock using a solid-state coil (as opposed to spinning magnet).

Use of an extremely low frequency magnetic field to transmit the data. This differs from usual data transmission in that in a radio transmission, the electromagnetic field propagates in space over time, attenuating generally at the square of the distance from the transmitter. However, such transmissions do not readily propagate through rock.

In the RBS system, extremely low frequency magnetic field is used. At the low frequencies used in the RBS system, the self-propagating electromagnetic wave is not utilised. Instead, the strength of the magnetic field at a location distant from the transmitter is described more accurately by static magnetic equations. The “static” magnetic fields are attenuated generally at the cube of the distance from the transmitter, but are generally not strongly attenuated by rock (ignoring magnetite drifts and other high metal concentrations etc).

The use of these very low frequency magnetic field signals is therefore preferred. The cubic attenuation gives a very small received signal—but this signal was found to be often still greater than a strongly attenuated radio wave in the same environment.

The RBS system provides for in-situ transmission of data (e.g. from holes) over large ranges using extremely low frequency fields where the transmitter fits into a bore hole (or other small area).

In order to provide increased robustness for signal transmission, the RBS system uses multiple frequency shift keying or optionally uses frequency hopped spread spectrum techniques, utilising low cross correlation Gold Codes to increase the effective signal to noise ratio at the receiver, and to negate the effects of strong harmonic noise sources.

In order to increase the ability to operate in harsh environments, the RBS system uses encasing compound expansion ports in the transmitter. The encasing compound is used to mechanically locate the electronics, while also providing sealing against fluid ingress. The compound is readily moulded and has a high operational temperature. The expansion ports provide protection to the transmitter electronics and sub-systems by allowing the encasing compound to expand into the expansion ports instead of linearly displacing the electronics.

The expansion ports are fabricated using a mechanical feature to prevent compound ingress during moulding. The expansion port contains atmospheric air or other gasses at environmental temperature during the moulding process. It is also possible to form an expansion port using foam or similar materials.

At elevated temperatures, the moulded compound can compress the expansion ports, that are distributed through the transmitter, preventing large lateral displacement of the moulding compound out the ends of the transmitter core.

Whilst the first embodiments will be described with reference to the transmission of temperature and pressure data, the transmitter/receiver pair of the first embodiment are effectively a ‘rock-modem’. The ability to send data over relatively large distances through rock (compared to daisy chained radio technology) has many other usages where data other than temperature or pressure may be sent.

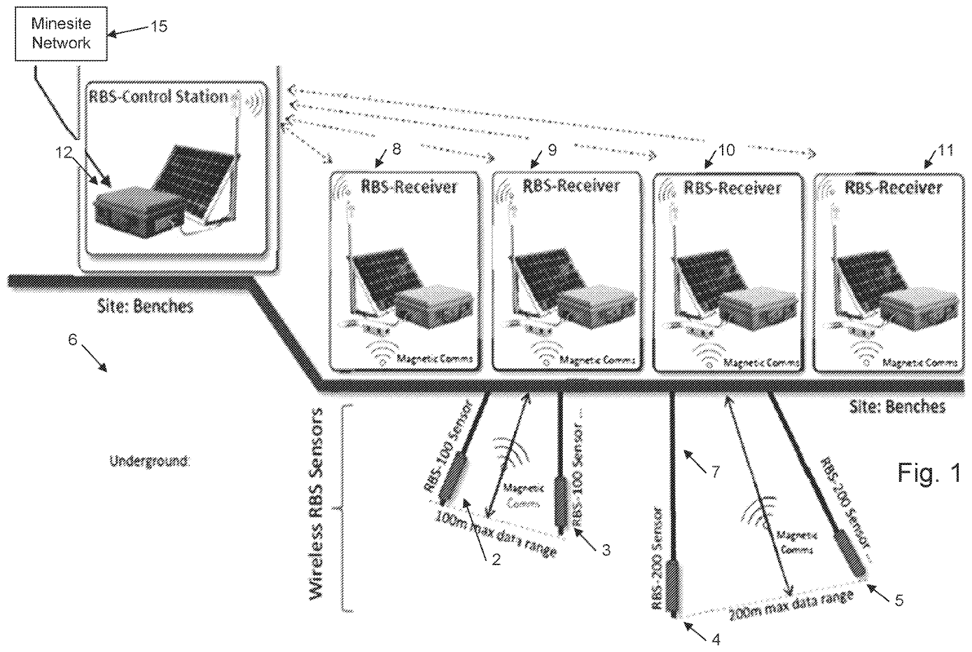

The core components of the RBS system architecture are shown schematically in FIG. 1.

In this arrangement 1 a series of RBS sensors 2-5 are installed underground 6 up to a maximum transmission depth, down a borehole or the like. Sensors may also be installed in tunnels, other cavities, or covered over at a later date. Each sensor communicates with one or more RBS-receivers e.g. 8-11. The RBS Receivers are in turn connected wirelessly to a RBS control station 12. The control station is in turn optionally interconnected to the mine site internal network 15. Received data is typically retrieved via the RBS control station, but can be directly obtained from an RBS receiver if necessary. The RBS control station 12 can in turn be connected to an external network.

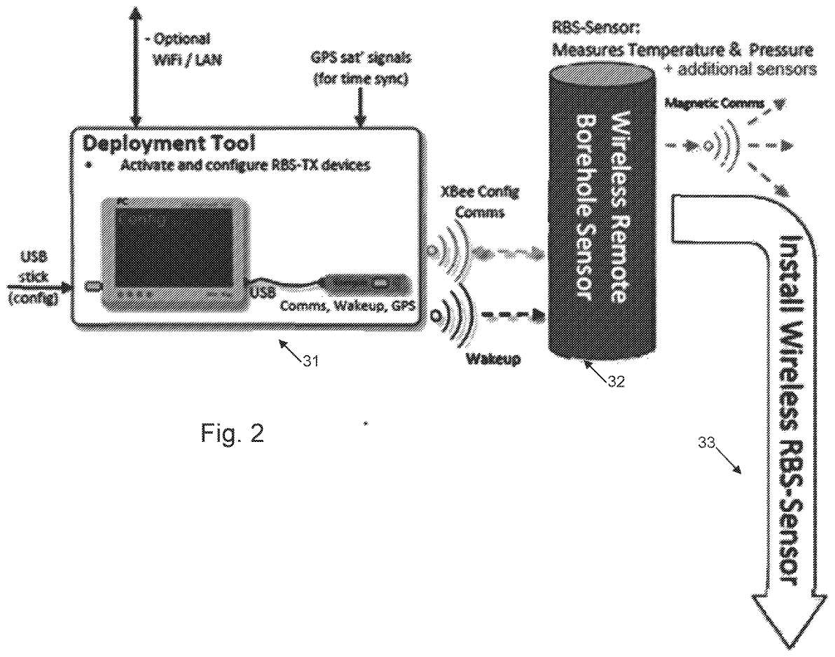

Turning to FIG. 2, initial deployment of each wireless remote borehole sensor e.g. 32 is provided via a deployment unit 31 which is a networked unit having gps and or Network Time Protocol (NTP) interconnectivity. Once programmed the RBS is deployed or installed 33 into an underground or remote environment.

The system is deployed and operates as follows: A transmission schedule is initially developed for the RBS-Sensors that are to be deployed.

This schedule is uploaded to the RBS-Control Station (12 of FIG. 1)—so it can co-ordinate the RBS-Receiver magnetic recordings. The schedule is also transferred to the Deployment tool 31. The RBS-Readers, e.g. 8 of FIG. 1, are deployed within reception range of the planned RBS-Sensor installation locations. The RBS-Readers all have GPS modules, allowing them to determine their position and universal time—for schedule synchronisation purposes. RBS-Readers can also synchronise their time to the RBS-Control Station.

The RBS-Control Station 12 is placed within WiFi reception range of the RBS-Receivers 8-11. The antennas from these systems are aligned and communication checked. The RBS-Control Station 12 is optionally connected to the mine site's LAN system 15.

User communication to the RBS-Control Station can be carried out using a PC ‘browser’ via the RBS-Control Station's internal web server or other software. PC connection can be made locally (21 of FIG. 2), via the RBS-Control Station's Master Wifi, or remotely via the sites LAN (on site or offsite of the appropriate privileges are granted).

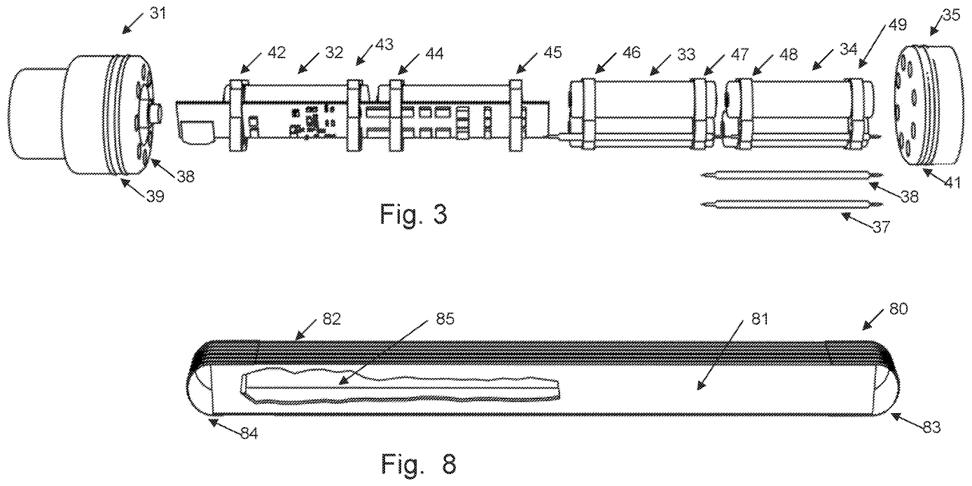

Turning to FIG. 3, the deployment tool 31 is then used to activate one or more RBS-Sensors 32. Each RBS-Sensor is configured by the deployment tool to transmit data according to the predetermined transmission/measurement schedule. The deployment tool can also put the RBS-Sensor into various transmission modes. e.g. Sinusoidal or Frequency Hopped Spread Spectrum Mode.—Send measured data or send sequentially numbered engineering test packets. A number of other configuration options are also provided (e.g. Transmission hold offs, Mission life, Long life mode). These modes can be updated on a needs basis.

A number of RBS-Sensor installation locations are prepared. These will typically comprise of one or more bore holes (e.g. 7 of FIG. 1). Multiple RBS-Sensors may be deployed into a hole. The configured RBS-Sensors are installed into their planned locations—typically down a bore hole. Grouting may be used in the bore hole.

### RBS Sensor Construction

One form of elongated RBS Sensor Construction will now be described.

Turning initially to FIG. 3 there is illustrated an exploded view of the core portions of the RBS sensor. These include a first pressure sensor end cap 31 for holding a series of sensors and having a series of expansion holes 38, and o-rings 39. A main circuit board assembly 32 includes Microcontroller, and transmitter circuits further described hereinafter. There is also provided a series of battery cells 33, 34, with attached expansion ports 36, 37 which allow for thermal expansion and contraction of the overall arrangement. An installation endcap 35 is also provided with o-rings 41.

A series of chassis inserts 42 to 49 are also provided to allow for relative thermal movement of the PCT and batteries.

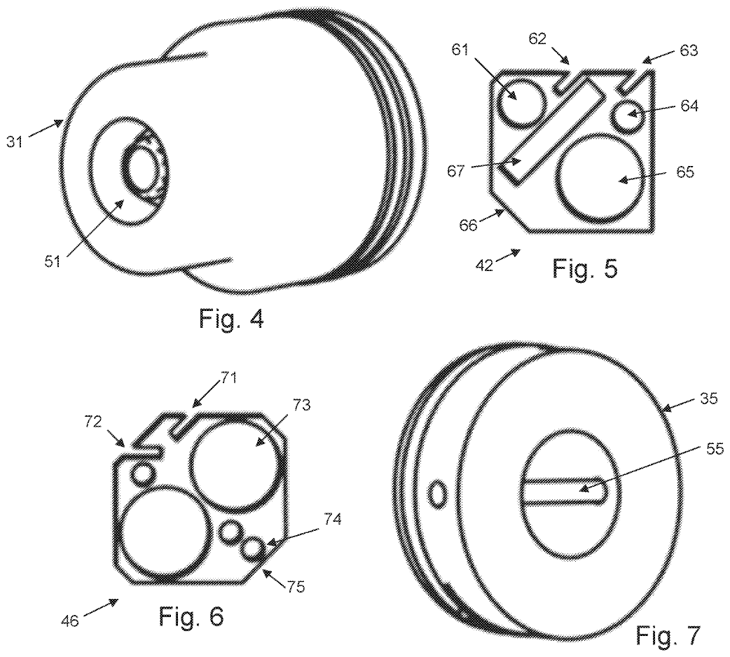

FIG. 4 illustrates a side view of the pressure end cap 31 showing the pressure sensor 51.

FIG. 5 illustrates an end on view of the transmitter PCB and chassis inserts e.g. 42 of FIG. 3. The chassis insert includes a number of highlights, including: diode clamp slot and silicone flow hole 61, temperature sensor slot 62, guide slots 63, expansion port slot 64, CPU and Pressure battery slot 65, diagonal silicone flow path 66 and transmitter PCB slot and silicone flow path 67. Once inserted into the core the electronics and battery can be encased in silicone, with the expansion slots (e.g 38 of FIG. 3) allowing for thermal expansion of the silicone.

FIG. 6 illustrates an end view of the transmission batteries and chassis inserts 46 of FIG. 3. Again, highlighted features include: temperature sensor and guide slots 71, transmitter battery slot 73, small holes 74, diagonal silicone flow paths 75 and power supply looming guide slots 72.

FIG. 7 illustrates a further side view of the installation end cap 35 of FIG. 3, illustrating an installation attachment rod 55 for attaching a wire line or the like for lowering into a down hole.

Turning now to FIG. 8, there is shown the steel core 81, which can be of a hollow or L-section form. The steel core is illustrated partially in cutaway to illustrate internal cavity 85, into which the electronics and batteries of FIG. 3 can be inserted inside the steel core. The ends of the steel core included expansion joints 83, 84, which allow for expansion and contraction of a transversely wound insulated transmitter wire 82.

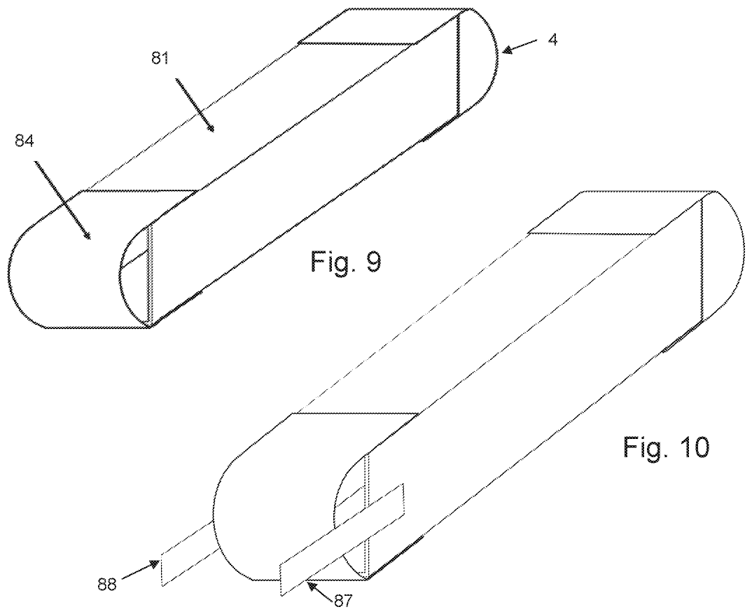

FIG. 9 illustrates one form of preform steel core 81 and expansion joints 84, 85.

FIG. 10 illustrates an alternative form of preform steel core and expansion joints with guide tabs 87, 88.

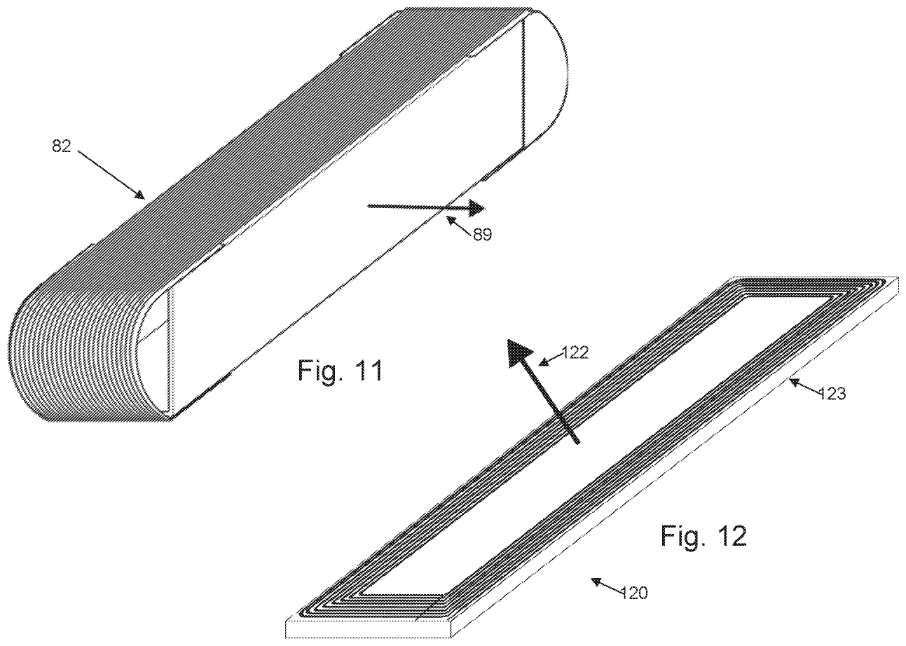

FIG. 11 illustrates the elongated transverse transmitter winding 82 which, when driven by an electric current, results in a magnetic field maximised in the direction 89, in accordance with Faraday's law.

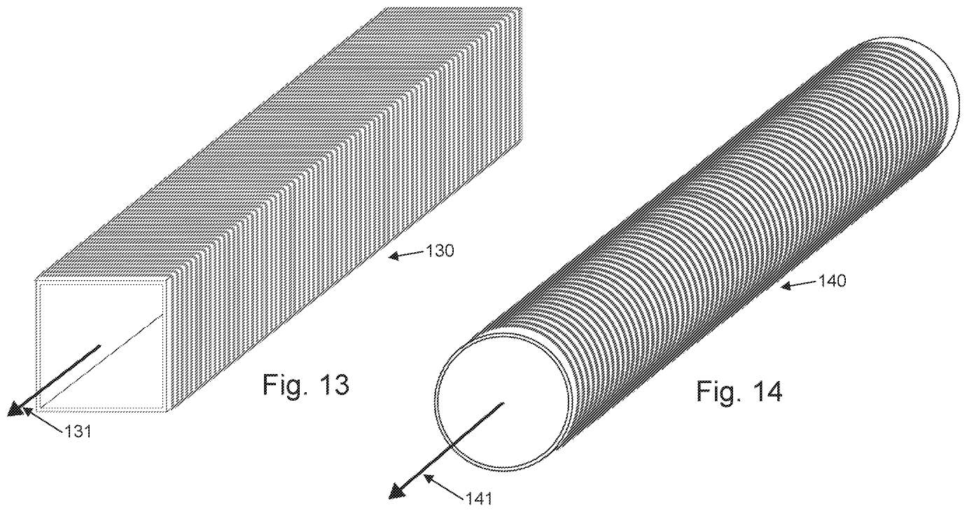

Alternatively, other forms of coil windings are possible. For example, FIG. 12 illustrates 120 an alternative form of transverse coil winding 121 on former 123 which would result in magnetic field 122.

Alternatively, radial windings are possible. For example, FIG. 13 illustrates a first square radial winding 130 having resultant magnetic field 131. FIG. 14 illustrates a radial winding 140 having resultant magnetic field 141.

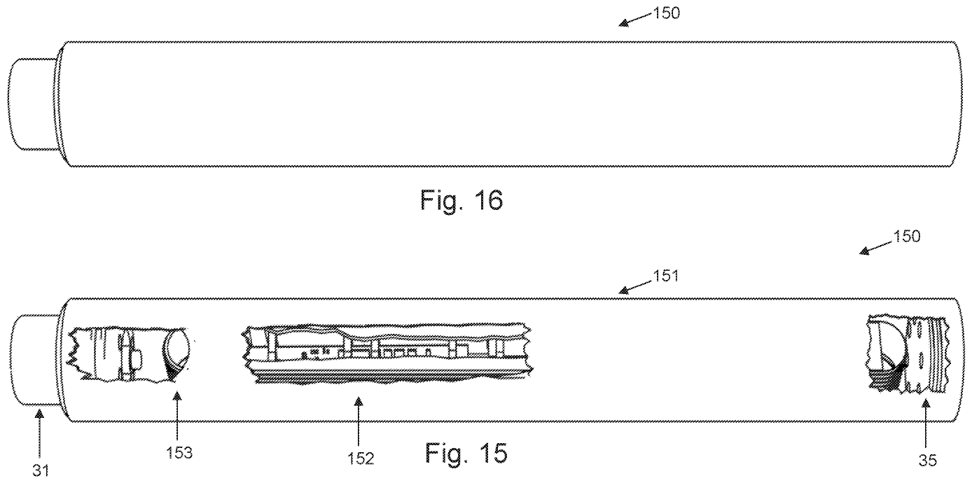

Turning now to FIG. 15, the assembled electronics and steel core and transverse transmitter windings are inserted within a fiberglass cylindrical enclosure 151, with FIG. 15 showing a partially cut away view, showing the core electronic assemblies 152, the activation coil 153, and end caps 31, 35.

FIG. 16 illustrates the resultant overall RBS sensor 150 in a final assembled form.

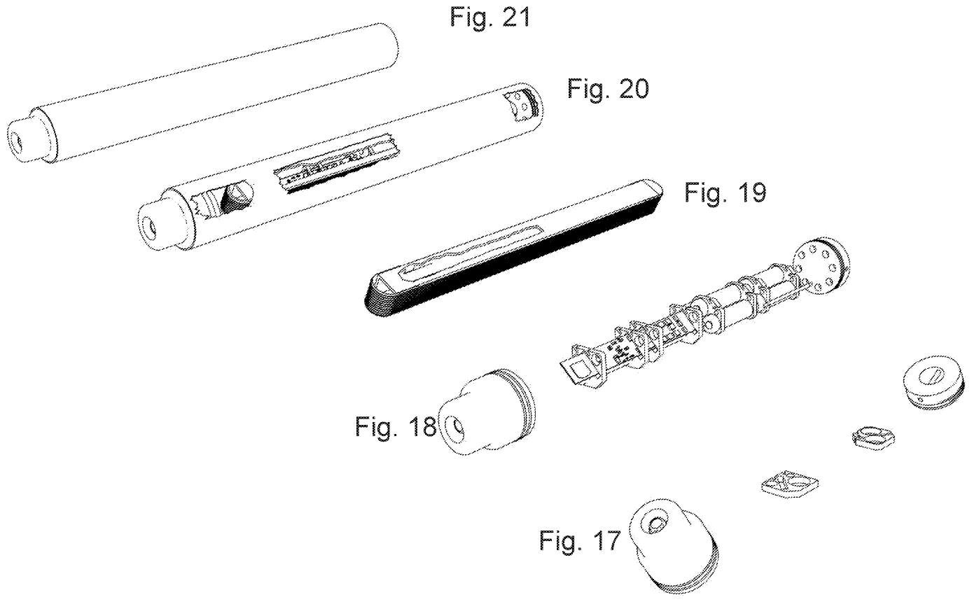

Turning to FIG. 17 to FIG. 21, there is illustrated an alternative side view of the assembly process.

The core can be constructed of steel, but may be made of laminated steel or silicone steel or other ferrous material. The expansion joints are made of silicone steel with two layers of reinforced silicone matting, to avoid interaction between coil windings and the core (failure to avoid this interaction could cause the insulation to be damaged and compromise the integrity of the coil). They could be made of any non-abrasive material.

The transmitter windings can be enamelled copper or any other insulated wire.

### RBS Electronics

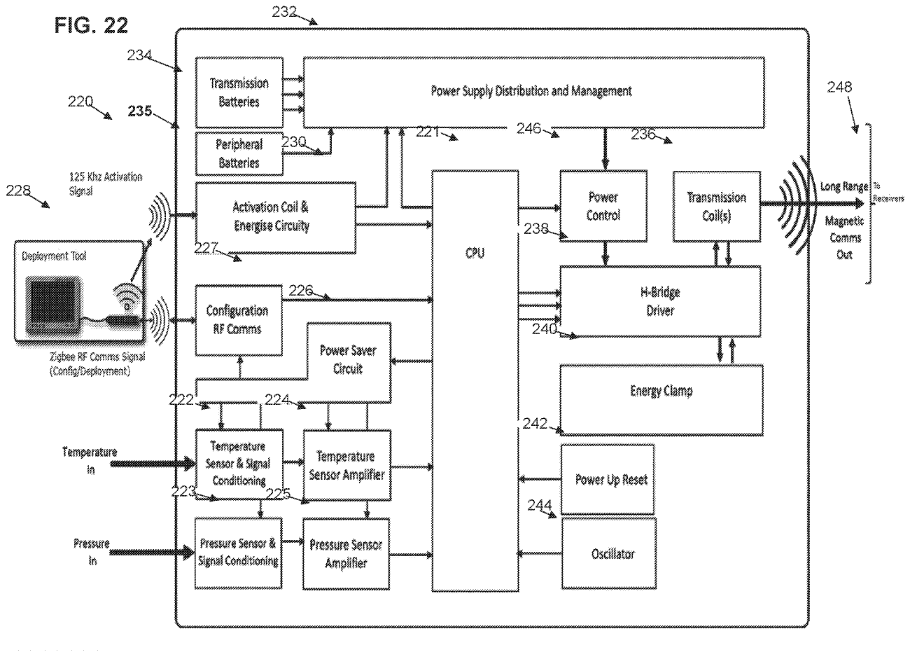

Turning now to FIG. 22, there is illustrated schematically, one form of RBS sensor electronic subsystem 220. The subsystem can be controlled by a central microcontroller 221. Sensor inputs can be provided by temperature and pressure sensor systems 222, 223. With the sensed signal being amplified 224, 225 before being input to the microcontroller 221. The sensors are activated in accordance with a time schedule under the control of power saving circuit 226.

During setup the microcontroller can be programmed via wireless interface 227 before deployment, utilising development interface 228. In the field the RBS sensor can be activated via activation circuitry 230 which responds to a unique activation frequency signal.

The battery system can be divided into transmission batteries 234 and peripheral batteries 235 under the power supply distribution and management system 232. Power can be monitored by power unit 246 and delivered to H-bridge driver circuit 238 for driving the transmission coil 236, with the delivered energy being clamped via clamp circuitry 240.

In addition power up circuit 242 and timing oscillator 244 can also be provided for the microcontroller 221.

A pressure sensor can also sits outside the main metal core. The whole assembly is potted in silicone to mechanically locate components and provide environmental protection. An optional programming port also emerges from the metal core. This remains embedded in Silicone for deployment.

Data Transmissions from RBS Sensors

In operation, the RBS-Sensors take their sensor data measurements by ‘wake up’ s before schedules transmission time.

Frequency Shift Keying (64-FSK), or Frequency Hopped Spread Spectrum Frequency Shift Keying (FHSS-FSK) can be used to transmit the data. For 64-FSK: 64 frequencies nominally starting at 20.0 Hz, and nominally spaced at 0.1 Hz can be used to transmit a ‘Symbol’. For 64-FSK, each symbol represents 6 bits. Three symbols are required to send 16 bits of information plus two system usage bits. For FHSS-FSK: The same 20.0 Hz and spaced at 0.1 Hz ‘base’ frequencies are used, but a ‘delta offset frequency’ is added modulo 64 style every full PWM cycle. The pseudo random ‘delta offset frequency’ amount is determined using four families of Gold Codes. With four code families only two symbols are needed to send two 8 bit data values. It is possible to change the number of code families and the frequency spacing to send other amounts of data in a given symbol period. Alternative transmission schema can be used.

In alternative embodiments, if a greater number of transmitters are required, then the low cross correlation properties of the Gold Codes (or other codes) may be used to provide Code Division Multiple Access (CDMA) functionality. This allows several RBS-Sensors to transmit at the same time.

The RBS-Receivers are configured via the RBS-Control Station to record the RBS-Sensor transmission the prescribed times. It is also possible to configure RBS-Receivers individually.

The RBS-receivers utilise a magnetometer to detect the magnetic transmission files from the RBS-transmitters. An amplifier and analogue to digital converboard digitises the received signal. The digitised data is streamed to a computer for archiving and re-transmission. The RBS-Receivers archive the received data into a file, and then send this file via a WiFi repeater to the RBS-Control Station. If there is no communication link, or the link fails, the RBS-Receiver will attempt to transfer the file at a later date. The RBS-Receiver and RBS-Control Stations have their own solar panels and battery supply. The devices can run several days without additional charge (depending on the initial charge state). The RBS-Control Station receives files from all RBS-Receivers. There may be multiple recordings, made by multiple RBS-Receivers, of a given RBS-Sensor transmission.

The RBS-Control Station demodulates the received magnetic file recordings using the appropriate signal processing methods to extract the data from either the 64-FSK signal or the (FHSS-FSK).

Uses can access data from the RBS-Control Station locally (via WiFi) or remotely via the site's LAN. The RBS-Control Station internal webserver provides user management and data access.

The extracted data is stored and is accessible in in three formats: i) User file (.csv spread sheet file) This contains timestamped temperature and pressure data for each RBS Sensor. ii) The Engineering file (.csv spreadsheet file) Contains all RBS-Reader timestamped temperature and pressure data for a given RBS-Sensor transmission. iii) RBS-Receiver raw magnetic recordings: (.csv spreadsheet file), The raw magnetometer tri-axial data from a given recording. Additional analysis data such as graphs, log files, or other metrics may also be obtained from the system.

### Alternative Remote Bore Hole System (RBS) Wireless Underground Transmission.

To transmit data from underground locations in mines and their associated environments, the following further methods can also be used in the embodiments to further meet the technical challenges and environmental constraints.

Extremely low frequency magnetic field generation: Propagating electromagnetic fields (radio waves) are normally severely attenuated when travelling through rock, concrete, water and salty water. The higher the frequency of the propagating electromagnetic wave, the greater signal attenuation through these mediums. The presence of rock or concrete (etc) in the transmission path causes only low signal attenuation for extremely low frequency magnetic fields when compared to the higher frequency propagating electromagnetic waves. For this reason, the wireless underground transmitter system of the embodiments can use an extremely low frequency magnetic field to transmit its data.

Because the time rate of change of the generated magnetic field is extremely low, the time-dependent components of Maxwell's equations tend to zero. This means that the signal does not propagate like an electromagnetic radio wave studied in normal electromagnetic theory courses. The extremely low frequency magnetic field signal has very similar properties to a static magnetic field, including a signal attenuation over the transmission range “R” proportional to 1/R³. Hence, doubling the transmission distance leads to attenuation of the received magnetic signal by a factor of 8.

The resultant generated magnetic field has the spatial characteristics of a magnetic field given by a dipole equation. For a stationary transmitter, the magnetic field at a given reception point has a fixed orientation vector, but varying signal magnitude. This contrasts greatly with the magnetic field generated by say a spinning magnet—which has a constant magnitude at a given reception point, but a rotating orientation vector.

Stable transmission frequencies: The high spatial attenuation factor of the low frequency magnetic signal means that over a transmission range of 200 m, for example, the received magnetic field strength is millions of times weaker than the Earth's magnetic field. To allow the signal from the transmitter to be detected against a background magnetic signal such as the Earth's magnetic field, which millions of times higher than the transmitter signal, the transmitter generates an oscillating magnetic field, where the given oscillation frequencies are pre-determined and very periodically stable. This allows the transmitted signal to be selectively tuned, and out-of-band band signals rejected. This also facilitates the use of multiple transmitters utilizing the transmission channel if desired.

Solenoidal Core Form Factor: The material of the solenoidal core is chosen to maximise the solenoid's magnetic field strength and is chosen for a high relative permeability (μᵣ) compared to a vacuum (μ₀). The hollow form factor of the core allows the batteries and electronics to be housed inside the core's hollow section (FIG. 15). The core's strength protects the electronics and batteries from environmental stresses. The electronics and batteries are also protected from the high magnetic fields in the region, as the fields are strongest within the core's high μᵣ walls as compared to the cores hollow cross section, which has a permeability close to that of μ₀.

The form factor of the core may optionally be formed by several sections, such as two “L” sections, or semi circles, combined to make the solenoid. This allows the internal electronics and batteries to be more conveniently fitted to the central core region.

### Solenoidal Core and Transverse Coil Windings

The magnetic field is created by driving an oscillating signal into solenoidal wire windings around a ferrous core. The assembly is generally elongated and size-constrained so that the transmitter may fit into mining holes and other small spaces, to allow in-situ use. The battery power supplies that drive the solenoidal coil are subject to the same size constraints.

To maximise the signal-to-noise ratio at the receiver, the largest magnetic field possible must be generated subject to the size and power supply constraints. This is typically achieved by using solenoid windings with large enclosed areas, high drive currents, and many turns of wire. Due to the extreme size and power supply constraints, it is not possible to have winding core areas of many tens of meters, with external generators to supply large currents.

To maximise the magnetic field for in-situ operation (e.g. in down holes), additional magnetic field signal gain is achieved by preferably applying the coil windings to the metal core in a transverse orientation (FIG. 8). This contrasts with almost all solenoid windings, which are typically applied radially. The transverse winding orientation results in a coil area (height*length) that is larger than the corresponding radially wound coil area (π*radius²), resulting in a greater magnetic field emerging for this transverse design.

Solenoidal Coil: In addition to the transversal winding orientation of the core: The number of windings and winging-wire area of the coil are optimised, subject the enclosure's dimensional constraints, to result in a large amount of current flow for the greatest number of windings, with the minimum possible inductance. This results in the largest generated magnetic field for the least energy loss. In particular, the inductance is managed so that the magnetic field magnitude at the highest transmission frequency is not attenuated significantly compared to the magnetic field magnitude at the lowest transmission frequency.

Coil Driver: The H-bridge circuit (238 of FIG. 22), driven by discrete transistors and controlled directly by the transmitter's microprocessor, is used to efficiently energise the solenoidal coil. Because of the extremely low drive frequencies, the need for extremely short ‘dead-bands’ between phase switching is not required—facilitating the use of discrete transistors as opposed to driving chips. Deadband control (shoot through protection) can be of a sufficiently large period that it may be generated within the microprocessor itself. For use in high temperature environments (e.g. geothermal environments) a set of diodes in series are used to clamp the high voltage transients during switching, protecting the driving FETs. This used instead of the of the usual electrolytic capacitors, which are not rated for extremely high temperatures over long durations. The diode clamp may be of a passive series design or switched active design.

### Enhanced Frequency Hopped Spread Spectrum (FHSS) and Frequency Shift Keying (FSK)

Because the magnetic fields received by receivers are extremely weak, various methods can be used to maximize the received magnetic signal to noise ratio. The example below is given for the case of two 8-bit data bytes (e.g. sensed temperature and pressure) and three transmitted symbols—but may be generalized to any number of data bytes or transmitted symbols.
1. Symbols: In a pure n-FSK modulation scheme, ‘n’ represents the number of frequencies reserved to represent each symbol value. For 64-FSK, there are 64 frequencies representing the data values 0 to 63. This is the equivalent of 6 bits of binary information per symbol (2⁶=64). For the example where two 8-bit data bytes (16 bits in total) are to be communicated, at least 3×6-bit symbols are required.
2. Bit Packing: The binary bits that make up the data to be communicated are partitioned into one or more symbols that will be transmitted.

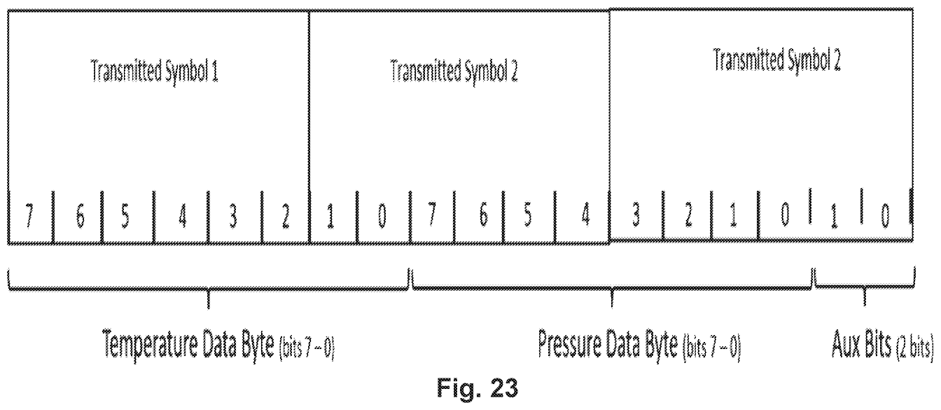

For example, as shown in FIG. 23, if two 8-bit data bytes are to be communicated, then 8 bits of the first data byte are distributed amongst the first and second symbols. The second data byte is distributed amongst the second and third symbols. This leaves two extra bits, that may be used for additional data resolution error, parity checking, or some other purpose.
3. Frequency Range: The lowest FSK frequency is chosen to suit the attenuation constraints of magnetic fields in non-magnetic channel paths (for example rock). This requires an extremely low frequency magnetic field, for example 20 Hz as the base frequency for a symbol data value of 0.

The inter-frequency spacing between symbols is chosen to meet the requirements for error free detection and signal discrimination during demodulation. The inter-frequency spacing is also chosen to limit the highest symbol frequency, so that it meets the requirements of the transmitter solenoid, where frequencies that are too high are severely attenuated. For example, an inter-frequency spacing of 1 nanoHz is not practicable, as the transmission time required to discriminate between frequencies 1 nanoHz apart is far too long. At the other extreme, an inter-frequency spacing of 1 Hz is not practicable, as, assuming 64 FSK is used, the highest symbol frequency is 64 Hz above the lowest base frequency. Selecting a solenoid with an inductance to accommodate such a frequency range would be impractical.

An example suitable symbol inter frequency spacing is 0.1 Hz. With a lowest base frequency of 20 Hz, for a pure FSK system, and an inter symbol spacing of 0.1 Hz, the highest symbol frequency is 26.3 Hz.
4. Symbol Base Frequency: With the value of each symbol determined (step 2), the transmission frequency for a pure n-FSK symbol can be determined. e.g. if the symbol to be transmitted is “1”, then the frequency to be transmitted (if this was a pure n-FSK system) would be 20.1 Hz.
5. Generating Switching Wave Forms: The microcontroller's internal timer interrupt counter registers are configured with an initial value to generate twice the desired symbol frequency calculated in step 4 above.

Microcontrollers can generate an internal interrupt when the automatic timer counter registers are incremented (or decremented) to a pre-determined value. When the interrupt occurs, the microcontroller changes the state of the H-bridge FET gate drives, to generate the deadband and switching waveforms. This alternately charges the coil in one ‘polarity’, and then at the next switching cycle, reverses the ‘polarity’.

If no further steps were taken, a pure n-FSK signal would be generated at this point. However additional steps, which can increase the signal to noise ratio at the receiver, and allow long distance transmissions to be made, using the extremely low frequency magnetic fields, transmitted from underground, in-situ, can also be taken.
6. Increasing the Signal to Noise Ratio: To increase the signal to noise ratio at the receiver, an enhanced modulation method can be used to apply frequency hop spread spectrum (FHSS) to the FSK symbol.

A pseudo-random frequency deviation is applied to the base FSK symbol frequency every cycle. This changes the transmitted frequency of the transmitted signal each full cycle period. i.e. every 2 interrupts, or multiple of 2 interrupts. The frequency is not changed every H-bridge switching edge, so that the ‘+ve’ and ‘−ve’ halves of the coil charging cycle match and the DC bias across the transmitting coil is kept to OV.

To demodulate the received FHSS-nFSK signal, it is locally cross-correlated with a reference signal that contains the exact sequence of transmitted pseudo-random frequencies. When there is an exact match between the received signal and the reference signal, the cross-correlation peak is higher than non-correlating ‘noise’ peaks.

As a point of difference, instead of having FHSS sequence codes that are unique for each symbol, the wireless underground system of the embodiment can use the same frequency offset codes for each symbol. The frequency offsets generated by the re-used codes are added in modulo fashion to the base symbol frequency (calculated in step 4). Modulo addition of the frequency offsets are used to ‘wrapped around’ frequency additions that exceed the maximum desired solenoid fundamental frequency. The overflow amount is added to the lowest base symbol frequency. This keeps the transmitted bandwidth within the original bandwidth constraints, as dictated by the solenoid design and transmission medium constraints.
7. Further Increasing Battery Life. Transmission range or Received SNR: Because the same pseudo-random spreading offset codes sequence is used for all symbols, there is the option of increasing the number of spreading codes, thereby increasing the number of available bits per symbol. The microprocessor can be configured to use four spreading code sequences instead of one, allowing 64*4=256 data values to be sent during each symbol. This allows, for example, two 8-bit bytes to be sent in one symbol, thereby reducing the transmitted symbols from 3 to 2. This in turn lowers the transition time by ⅓ and increases battery life by ⅓. Conversely, if the overall transmission time is kept to the original length, then the remaining individual symbol transmission times can be increased into the period occupied by the now redundant symbol. This results in an increased transmission range or and increased received SNR for a given transmission range.
8. Multiple Transmitters operating simultaneously in the channel: The use of additional spreading code families also allows the operation of multiple transmitters at the same time. As the code spreading families are ‘orthogonal’ (low cross correlation values) the demodulator can distinguish between simultaneous transmission of different code families.
9 Applying Pseudo Random Frequency Offsets. When the microprocessor services the timer interrupt, that switches the state of the H-bridge driving the solenoid, it determines if a full switching cycle has completed. This occurs every second interrupt. If a full switching cycle has been completed, then a new timer reload value is required, to initialize the interrupt timer register counter. This has the effect of changing the transmission frequency for the next cycle. The new timer reload value (typically 11 bits or longer) is computed as follows:

$$newTimerReload = ( symbolFreqTimerReload - minFreqTimerReloadConst ) + freqHopDeltaTimerReload ) MOD maxFreqTimerReloadConst$$

where:
newTimerReload: is the new interrupt timer reload value (e.g. 16 bit value) that defines the new transmission
maxFreqTimerReloadConst: is the reload value constant to generate the maximum fundamental transmission frequency.
minFreqTimerReloadConst: is the reload value constant to generate the minimum fundamental transmission frequency.
symbolFreqTimerReload: is the reload value, if pure n-FSK was used to transmit the given symbol.
freqHopDeltaTimerReload: is the reload value for the FHSS frequency offset for this cycles (or integer number of cycles)
MOD performs modulo arithmetic, to wrap frequency offsets that are too high, around to the lower end of the transmission band.
10. Generating Pseudo Random Frequency Offsets.

The microprocessor interrupt counter requires a multiple bit timer reload value to span the desired transmission frequencies, from the minimum to the maximum transmission frequency (e.g. This may require an 11 bit number to load into the timer registers to cover the frequency hop range).

Pseudo random sequences that are easily generated in microprocessors generally produce streams of pseudo-random bits. The required number of these bits are rotated into a multi bit register to create the counter offset magnitude that spans the desired frequency range. e.g. for an 11 bit offset, the pseudo-random generator is ‘clocked’ 11 times, with the output pseudo-random bits shifted from LSB to MSB into the desired register.
11. Generating Pseudo Random Bit sequence.

It is desired that the pseudo-random bit sequence has a low cross correlation peak with other pseudo-random bit sequences. The pseudo-random bit sequence is generated by specifying start seed values into m-bit registers. The initial seed values create a unique code sequence or ‘family’. Different seed values create different spreading families. Each code sequence family has a low cross correlation with other code families. As noted in step 7, if just one code sequence family is used, then three symbols are required to send two 8-bit data bytes. If four code families are used, then only two symbols are needed to send the two 8-bit data bytes (assuming pure 64-FSK is used as the base symbol frequency). The microprocessor can be configured to use one or more families, of initial seed values, to generate the spreading code sequences. The pseudo-random codes can be generated using appropriately configured, maximum length sequence, shift registers (e.g Gold Code generators).
12. Spreading Code and Transmission length: Depending on the number of pseudo-random bits in the maximal length sequence, it is possible that the full sequence is used before the transmission time is completed. In this case the sequence is repeated as many times as needed, until the end of the desired symbol transmission length. The symbol transmission length needs to be long enough for the cross corelated peak, at the receiver end, to accumulate to a higher value than non-correlated ‘noise’ values.
13. Signal Processing the Received Signal: Before demodulation, the received signal can have band pass filtering, optionally common mode filtering and dynamic noise reduction applied. The dynamic noise reduction can measure the noise in the transmission channel and eliminate noisy signal bursts.
14. Demodulating the Received Signal: To determine which symbol was transmitted, a reference recording of each frequency-hopped transmission signal is kept in the demodulator. The demodulator may be in the receiver or another piece of equipment. The received signal-processed signal is cross correlated against stored reference recordings for each possible symbol. The cross correlation with the highest peak represents the transmitted symbol value. The reference recordings may also be synthesized. To radically reduce processing time, the received time domain signal and reference signals are first converted to the frequency domain. The frequency domain signals are then multiplied and then optionally converted back to the time domain, for cross correlation peak identification. Frequency domain multiplication is only performed over the channel pass band frequencies to further speedup computation times. The stored reference signals may be pre-converted to the frequency domain to further speed up processing times.
15. Receiver Synchronisation: All systems experience time drift. The time drift of the transmitter may be compensated for automatically re-configuring the receivers to start and finish their recordings based on the actual transmission times, which will drift. By observing how far the cross-correlation peak ‘lags’ point, deviates from the cross correlation ‘center point’, the time drift offset of the transmitter (leading or lagging) can be determined and compensated for.

It will be readily evident that other forms of sensors, such as positional sensors and communications sensors could also be utilised. Further, the RBS sensors could be placed in many different environments, for example, in bench stability monitoring, tailing dam monitoring, underground emergency communications and other possible environments.

### Further Embodiments

Further, other embodiments are possible, including those that rely on other forms of magnetic field fluctuation.

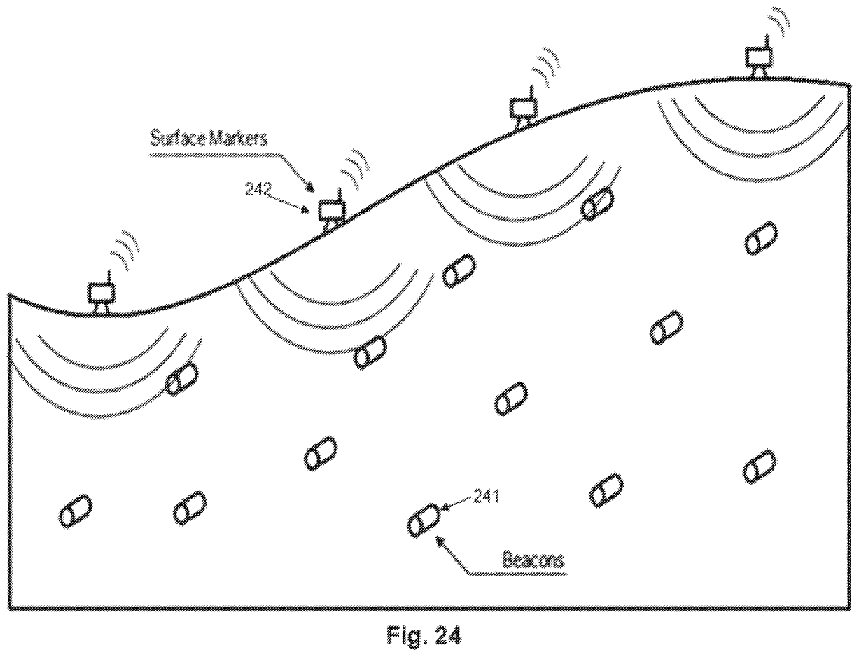

Turning now to FIG. 24 to FIG. 26, the operation of a further embodiment will now be described.

Turning initially to FIG. 24, in the second embodiment, the overall system is designed to measure bench stability and includes a series of buried beacons 241 which communicate with surface markers 242. The buried beacons 241 can be substantially of the form previously described. However, in this arrangement, the communication can take place via an oscillating diametrically magnetised permanent magnet driven by a motor to communicate information.

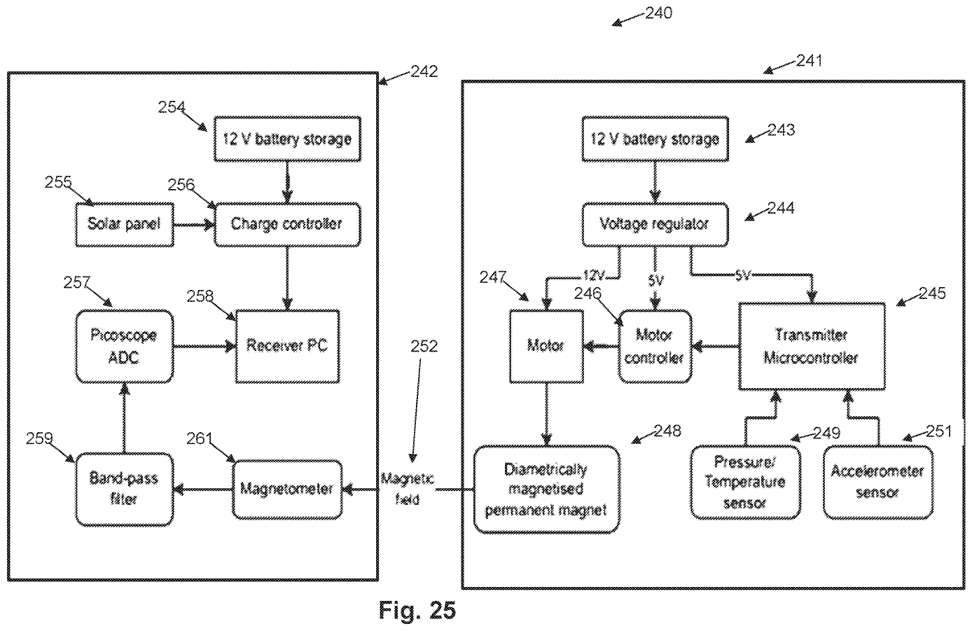

FIG. 25 illustrates schematically the operation 240 of the beacons 241 and surface markers 242. The beacons 241 include extensive long lasting battery storage 243. These are interconnected to a voltage regulator 244 to provide various output voltages. The output voltages drive microcontroller 245, motor controller 246 and motor 247. The microcontroller is, in turn, interconnected to pressure and temperature sensors 249 and accelerometer 251. The motor 247 drives a diametrically magnetised permanent magnet 248 to provide a low frequency fluctuating magnetic field for communication with the surface markers 242.

The surface markers include a magnetometer 261 for picking up changes in the magnetic field. The resulting signal is band pass filtered 259 before digital conversion 257. The resulting data is stored in local computer 258, which can be charged by soler panel 255, and battery storage 254 via charge controller 256. The Receiver PC 258 can include Wi-Fi communications capability for on communicating information.

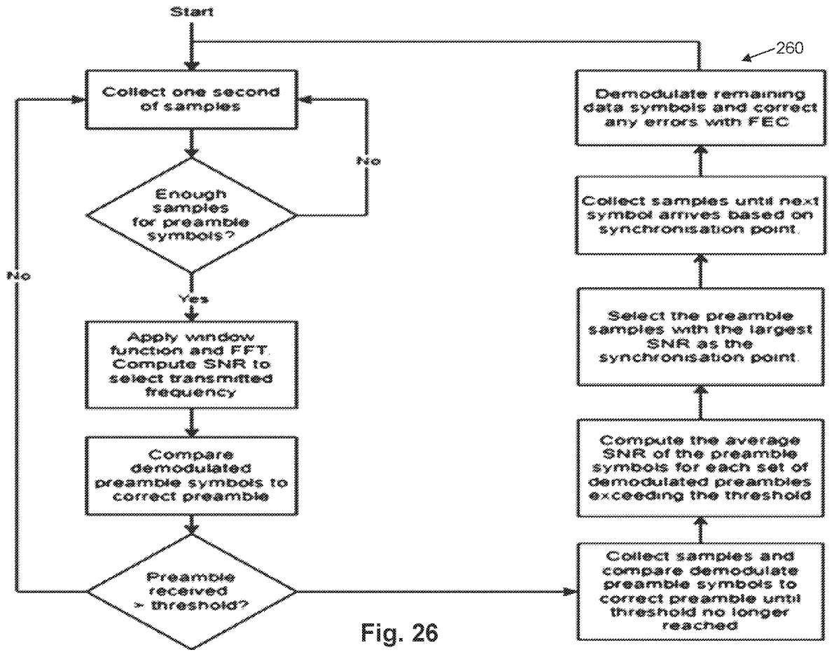

FIG. 26 illustrates one form of demodulation 260 of the received signal by the surface markers. While many different modulation techniques can be used, Frequency Shift Keying (FSK) is assumed. In particular, multiple M orthogonal frequencies can be used to provide a Multiple Frequency Shift Keying (MFSK) system for the communication of information. In one example, M=16. The demodulation can include Fourier transform processing by the computer to extract the original signal.

Ideally, the decoder can utilise a sliding window FFT to reduce noise in the decoded signal. Further, as the signal is transmitted in accordance with a pre-agreed intermittent schedule, preamble codes can be used to provide for time synchronisation. Further, error correction codes, such as Reed Solomon encoding of the transmitted signals can also be used to reduce error rates in the received signals.

FIG. 26 illustrates one form of flow chart for decoding of signals by the surface markers.

### INTERPRETATION

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. An underground low frequency wireless transmitter suitable for use in harsh environments including:
a core electronics and battery formed in an elongated unit;
an elongated hollow case formed from a high permeability material surrounding the core electronics,
a conductive transmission coil wrapped around the elongated case; and
at least one environmental sensor interconnected to the core electronics.

2. A transmitter as claimed in claim 1, wherein said conductive transmission coil is wrapped around the elongated hollow case in a transverse manner.

3. A transmitter as claimed in claim 1, wherein said core electronics and battery are able to undergo sliding movement within said elongated hollow case.

4. A transmitter as claimed in claim 1, wherein said high permeability material includes steel.

5. A transmitter as claimed in claim 1, further including endcaps located at each end of the elongated case, where one of the endcaps includes a pressure sensor.

6. A transmitter as claimed in claim 1, wherein the core electronics and battery are encased in a non conductive resin.

7. A transmitter as claimed in claim 6, wherein said hollow case includes a series of expansion slots for the thermal expansion of the resin into the slots.

8. A transmitter as claimed in claim 1, wherein the transmission scheme utilized by the transmitter utilizes Frequency Shift Keying (FSK).

9. A transmitter as claimed in claim 8, wherein the FSK lowest frequency is around 20 Hz, with about a 0.1 Hz spacing.

10. A transmitter as claimed in claim 8, wherein frequency hop spread spectrum is further added to the frequency shift keying.

11. A transmitter as claimed in claim 1, wherein the transmission coil is driven by a H-bridge driving circuit.

12. A transmitter as claimed in claim 1, wherein said transmissions occur at a frequency below about 300 Hz, and preferably below about 30 Hz.

13. (canceled)

14. An underground wireless transmission system including:
a sensor for sensing the underground environment and producing a corresponding data value;
a data value transmission unit for transmitting the data value to the surface, the transmission unit providing an encoded low frequency magnetic oscillating field, modulated with the data value;
a surface receiver unit including a magnetic sensor for sensing the encoded low frequency magnetic oscillating field and demodulating the data value from the field; and
a surface control unit connected to the surface receiver unit for collation of the data values from one or more surface control units.

15. A system as claimed in claim 14, wherein the data value transmission unit includes a conductive coil driven at a low frequency.

16. A system as claimed in claim 14, wherein the low frequency is below about 300 Hz.

17. A system as claimed in claim 14, wherein the data value transmission unit is encased in a first structure including a number of cavities and a second silicone material which is able to expand into the cavities when increases in temperature occur in the surrounding environment.

18. A system as claimed in claim 14, wherein the modulation includes a spread spectrum modulation.

19. A system as claimed in claim 14, wherein the data value transmission unit transmits data intermittently in accordance with a predetermined schedule.

20. A system as claimed in claim 14, wherein the surface receiver unit is solar powered.

21. A system as claimed in claim 14, wherein the magnetic sensor comprises a single or multi axis magnetometer.

22. A system as claimed in claim 14, wherein the sensing includes one of temperature, pressure or position.

23. A system as claimed in claim 14, wherein said data value is encoded in an error corrected format, such as Reed Solomon encoding, before sending.

24. (canceled)

25. A system as claimed in claim 14, wherein said data value is transmitted with one or more of the following: a preamble code: utilising Multiple Frequency Shift Keying (MFSK).

26. (canceled)

27. A system as claimed in claim 14, wherein said data value transmission unit creates the low frequency oscillating field by means of a rotating diametrically magnetised permanent magnet or electric coil.

28. An underground low frequency wireless transmitter suitable for use in harsh environments comprising:
a core electronics and battery formed in an elongated unit;
an elongated hollow case formed from a high permeability material surrounding the core electronics;
a low frequency oscillating electromagnetic field device; and
at least one environmental sensor interconnected to the core electronics.

29. (canceled)
